(19) United States
(12) Patent Application Publication
(10) Pub. No.: US 2013/0034080 A1
(43) Pub. Date: Feb. 7, 2013

(54) METHOD FOR FAST RETURN TO SOURCE RAT (RADIO ACCESS TECHNOLOGY) AFTER REDIRECTION TO TARGET RAT

(71) Applicants: Ming Yang, San Diego, CA (US); Tom Chin, San Diego, CA (US); Qingxin Chen, Del Mar, CA (US); Guangming Shi, San Diego, CA (US)

(72) Inventors: Ming Yang, San Diego, CA (US); Tom Chin, San Diego, CA (US); Qingxin Chen, Del Mar, CA (US); Guangming Shi, San Diego, CA (US)

(73) Assignee: Qualcomm Incorporated, San Diego, CA (US)

(21) Appl. No.: 13/407,665

(22) Filed: Feb. 28, 2012

Related U.S. Application Data
(60) Provisional application No. 61/514,193, filed on Aug. 2, 2011.

(51) Int. Cl. H04W 36/00

(52) U.S. Cl. 370/331

(57) ABSTRACT

A method of wireless communication includes receiving redirection information, from a source radio access technology (RAT), to set up a connection in a target RAT. The redirection information includes a fast return indication. A UE returns to the source RAT in accordance with the fast return indication after call release in the target RAT.

### CROSS-REFERENCE TO RELATED APPLICATION

This application claims the benefit under 35 U.S.C. §119(e) to U.S. Provisional Patent Application No. 61/514,193, entitled “METHOD FOR FAST RETURN TO SOURCE RAT (RADIO ACCESS TECHNOLOGY) AFTER REDIRECTION TO TARGET RAT,” filed on Aug. 2, 2011, the disclosure of which is expressly incorporated by reference herein in its entirety.

### BACKGROUND

1. Field

Aspects of the present disclosure relate generally to wireless communication systems, and more particularly, to a method for providing for fast return to a source radio access technology (RAT) after redirection to a target RAT, particularly in TDD-LTE networks and UMTS networks.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access technology or radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes receiving, from a source radio access technology (RAT), redirection information to set up a connection in a target RAT. The redirection information includes a fast return indication. The method also includes returning to the source RAT in accordance with the fast return indication after call release in the target RAT.

In another aspect, a method of wireless communication discloses sending redirection information to a UE (user equipment) to set up a connection in a target RAT (radio access technology), the redirection information including a fast return indication. The method also discloses receiving communication from the UE returning from the target RAT in accordance with the fast return indication.

Another aspect discloses an apparatus for wireless communication including means for receiving, from a source radio access technology (RAT), redirection information to set up a connection in a target RAT. The redirection information includes a fast return indication. Also included is a means for returning to the source RAT in accordance with the fast return indication after call release in the target RAT.

In another aspect, an apparatus for wireless communication includes a means for sending redirection information to a UE (user equipment) to set up a connection in a target RAT (radio access technology). The redirection information including a fast return indication. Also included is a means for receiving communication from the UE returning from the target RAT in accordance with the fast return indication.

In another aspect, a computer program product for wireless communications in a wireless network having a computer-readable medium is disclosed. The computer readable medium has program code recorded thereon which, when executed by the processor(s), causes the processor(s) to perform operations of receiving, from a source radio access technology (RAT), redirection information to set up a connection in a target RAT. The redirection information includes a fast return indication. The program code also causes the processor(s) to return to the source RAT in accordance with the fast return indication after call release in the target RAT.

In another aspect, the computer readable medium has program code that when executed by the processor(s), causes the processor(s) to perform the operation of sending redirection information to a UE (user equipment) to set up a connection in a target RAT (radio access technology). The redirection information includes a fast return indication. The program code also causes the processor(s) to receive communication from the UE returning from the target RAT in accordance with the fast return indication.

Another aspect discloses wireless communication having a memory and at least one processor coupled to the memory. The processor(s) is configured to receive, from a source radio access technology (RAT), redirection information to set up a connection in a target RAT. The redirection information includes a fast return indication. The processor(s) is also configured to return to the source RAT in accordance with the fast return indication after call release in the target RAT.

In another aspect, the processor is configured to send redirection information to a UE (user equipment) to set up a connection in a target RAT (radio access technology). The redirection information includes a fast return indication. The processor is also configured to receive communication from the UE returning from the target RAT in accordance with the fast return indication.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a downlink frame structure in a telecommunications system.

FIG. 3 is a block diagram conceptually illustrating an example frame structure in uplink communications.

FIG. 4 is a diagram conceptually illustrating an example of a base station/eNodeB and a UE in a telecommunications system.

FIG. 5 is a diagram illustrating a mixed network that includes coverage areas of a TD-SCDMA network and a TDD-LTE network.

FIG. 6 is a call flow diagram illustrating redirection to a target RAT and the return back to a source RAT.

FIG. 7 is a call flow diagram illustrating redirection to a target RAT and the fast return to the source RAT.

FIGS. 8A and 8B are block diagrams illustrating fast return of the UE back to the LTE network.

FIGS. 9A and 9B are block diagrams illustrating components for fast return processing according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The wireless network 100 includes a number of base stations (e.g., evolved node Bs (eNodeBs)) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

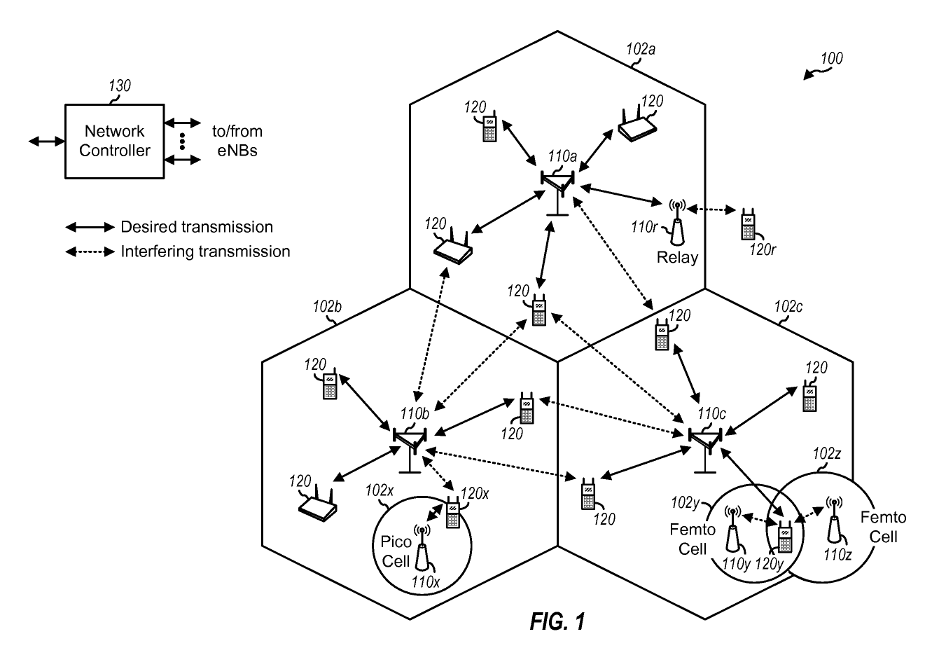

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 may also include relay stations. A relay station is a station that receives a transmission of data and/or other information from an upstream station (e.g., an eNodeB, UE, etc.) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

A network controller 130 may couple to a set of eNodeBs 110 and provide coordination and control for these eNodeBs 110. The network controller 130 may communicate with the eNodeBs 110 via a backhaul. The eNodeBs 110 may also communicate with one another, e.g., directly or indirectly via a wireless backhaul or a wireline backhaul.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a laptop computer, a cordless phone, a wireless local loop (WLL) station, a tablet, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth.

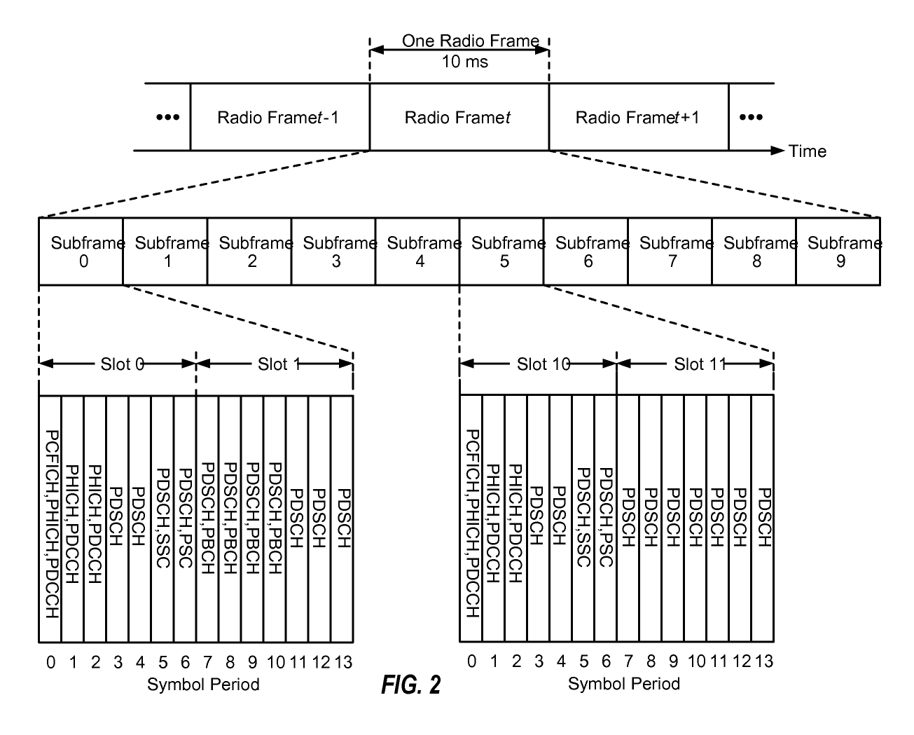

FIG. 2 shows a downlink FDD frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNodeB may send a primary synchronization signal (PSC or PSS) and a secondary synchronization signal (SSC or SSS) for each cell in the eNodeB. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on uplink and downlink resource allocation for UEs and power control information for uplink channels. The eNodeB may send a Physical Downlink Shared Channel (PDSCH) in the remaining symbol periods of each subframe. The PDSCH may carry data for UEs scheduled for data transmission on the downlink.

The eNodeB may send the PSC, SSC and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to groups of UEs in specific portions of the system bandwidth. The eNodeB may send the PSC, SSC, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. For symbols that are used for control channels, the resource elements not used for a reference signal in each symbol period may be arranged into resource element groups (REGs). Each REG may include four resource elements in one symbol period.

A UE may be within the coverage of multiple eNodeBs. One of these eNodeBs may be selected to serve the UE. The serving eNodeB may be selected based on various criteria such as received power, path loss, signal-to-noise ratio (SNR), etc.

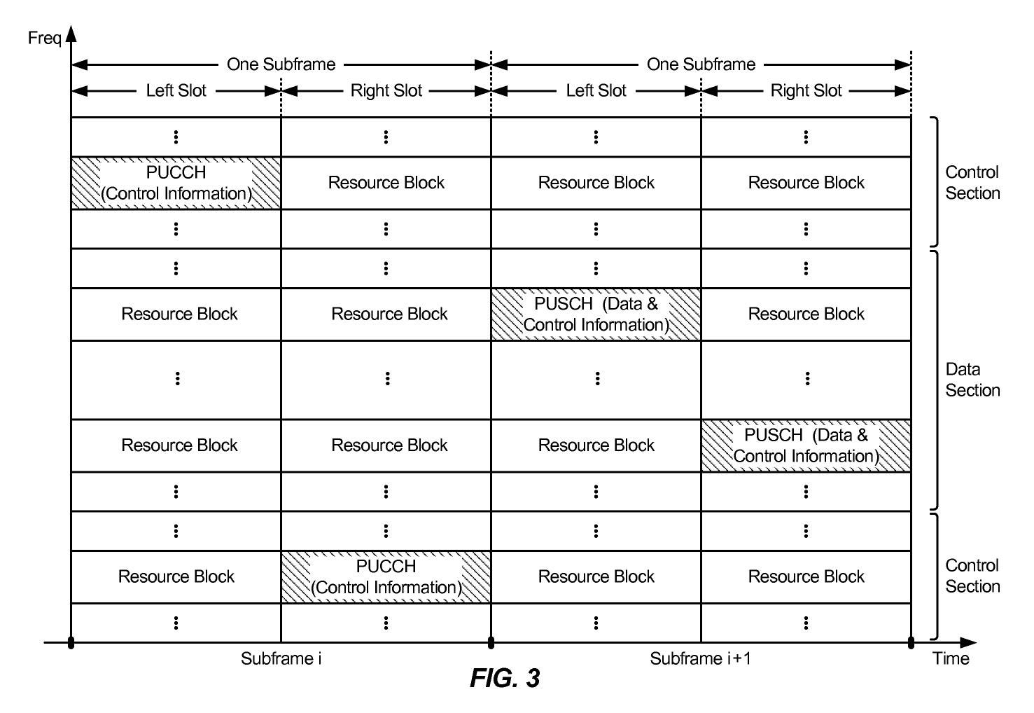

FIG. 3 is a block diagram conceptually illustrating an exemplary FDD and TDD (non-special subframe only) subframe structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNode B. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 3. According to one aspect, in relaxed single carrier operation, parallel channels may be transmitted on the UL resources. For example, a control and a data channel, parallel control channels, and parallel data channels may be transmitted by a UE.

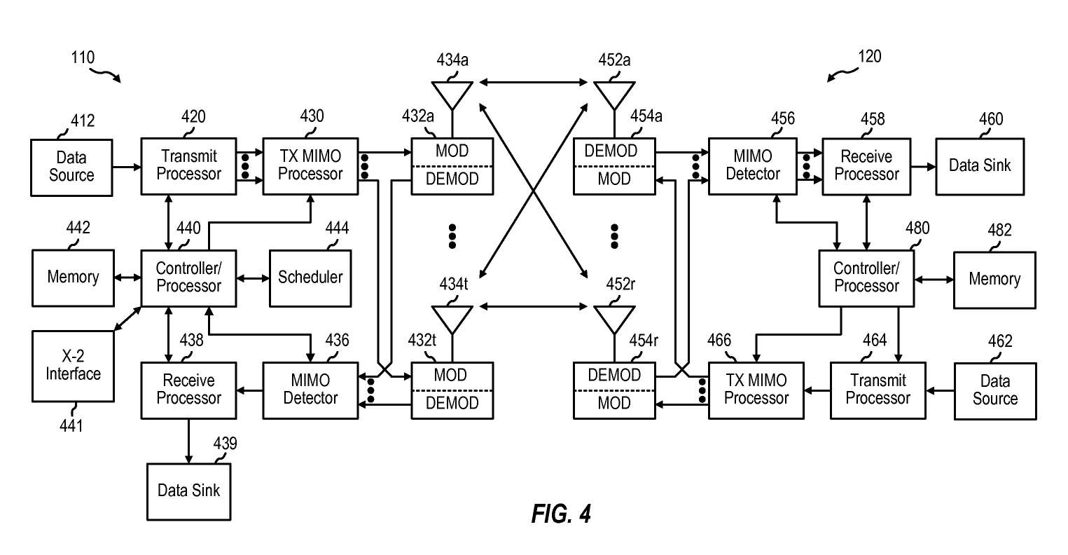

FIG. 4 shows a block diagram of a design of a base station/eNodeB 110 and a UE 120, which may be one of the base stations/eNodeBs and one of the UEs in FIG. 1. The base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 110. At the base station 110, the uplink signals from the UE 120 may be received by the antennas 434, processed by the demodulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send messages to other base stations, for example, over an X2 interface 441.

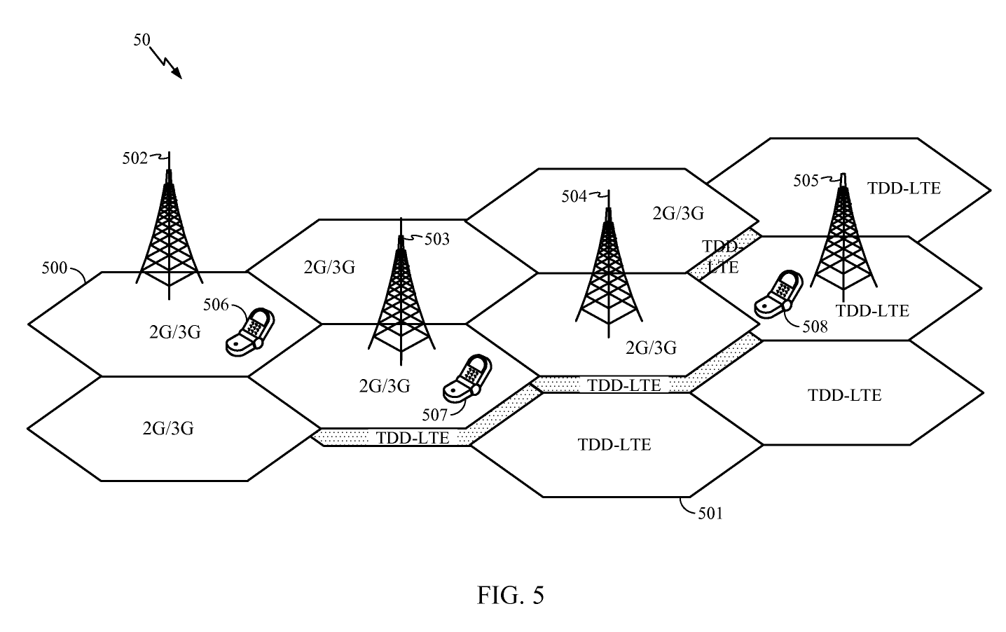

The controllers/processors 440 and 480 may direct the operation at the base station 110 and the UE 120, respectively. The processor 440 and/or other processors and modules at the base station 110 may perform or direct the execution of various processes for the techniques described herein. The processor 480 and/or other processors and modules at the UE 120 may also perform or direct the execution of the functional blocks illustrated in FIG. 5 and/or other processes for the techniques described herein. The memories 442 and 482 may store data and program codes for the base station 110 and the UE 120, respectively. A scheduler 444 may schedule UEs for data transmission on the downlink and/or uplink.

FIG. 5 is a diagram illustrating a mixed network 50 that includes coverage areas of a 2G/3G network 500 and a TDD-LTE network 501. The mixed network 50 includes areas where there is dual coverage between the 2G/3G network 500 and the TDD-LTE network 501 and other areas where there is only coverage of the individual networks. The base stations 502-505 operate node Bs for the 2G/3G network 500 and eNodeBs the TDD-LTE network 501. For example, the base station 502 may operate a single node B for the 2G/3G network 500, while the base station 505 may operate a single eNodeB for the TDD-LTE network 501. The base stations 503 and 504 may each operate one node B for the 2G/3G network 500 and an eNodeB for the TDD-LTE network 501. UEs, such as the UE 507 within the coverage area of base station 503, may connect for communication through both or either of the 2G/3G network 500 and the TDD-LTE network 501, while UEs such as the UEs 506 and 508 within the coverage areas of the base stations 502 and 505, respectively, would only be able to connect for communication through either the 2G/3G network 500 (for the UE 506 through the base station 502) or the TDD-LTE network 501 (for the UE 508 through the base station 505).

In order for a UE, such as the UE 507, to connect to both the 2G/3G network 500 and the TDD-LTE network 501, the UE includes both hardware and software enabling it to establish communication with the protocols of both 2G/3G and TDD-LTE technologies.

Blind redirection may be used, for load balancing and for circuit switched fall back (CSFB) from LTE to other radio access technologies (RATs), such as TD-SCDMA, UMTS FDD, UMTS TDD, and GSM. Generally, operators may have three or more RATs deployed. For example, in the initial deployment of LTE, it is not expected to provide an IMS (IP multimedia subsystem) voice service. Therefore, the voice service will fall back to other RATs for circuit-switched voice. The 3GPP standards have supported procedures to allow the voice call being set up when the UE is communicating with the TDD-LTE network, whether in idle or connected mode. Inter-RAT redirection may be blind or non-blind. Blind redirection occurs without knowledge of the radio conditions of the other technology. One advantage of blind redirection is that redirection may be executed quickly without additional measurements.

Redirection from one radio access technology (RAT) to another RAT may be used for load balancing, and circuit-switched fallback (CSFB) from LTE to other radio access technologies (RATs), such as TD-SCDMA, UMTS FDD, UMTS TDD, and GSM. CSFB is a feature that enables multimode UEs that are capable of communication with the 2G/3G network and the LTE network, to obtain circuit switched (CS) voice services while being camped on a LTE network. A CSFB capable UE may initiate a mobile-originated (MO) circuit switched (CS) voice call while the UE is communicating with the LTE network. This results in the UE being moved to a circuit switched capable RAT, such as 3G or 2G for a circuit switched voice call setup. A CSFB capable UE may be paged for a mobile-terminated (MT) voice call while the UE is communicating with the LTE network, resulting in the UE being moved to 3G or 2G for circuit switched voice call setup.

Upon completion of a circuit switched voice call, the UE returns to the LTE network for high speed data transactions. In current 3GPP specification, the UE uses standard mobility procedures to return to the LTE network and the UE may not be aware of its individual priorities for use at the next reselection.

The 2G/3G network triggers the UE's mobility from the 2G/3G network to the LTE network. For the 2G/3G network to distinguish a CSFB triggered circuit switched (CS) connection from a legacy circuit switched connection, the mobile switching center (MSC) needs to be aware of whether a circuit switched connection is setup due to CSFB. This involves an additional extensive inter-working operation between the UE, 2G/3G network, and the LTE network.

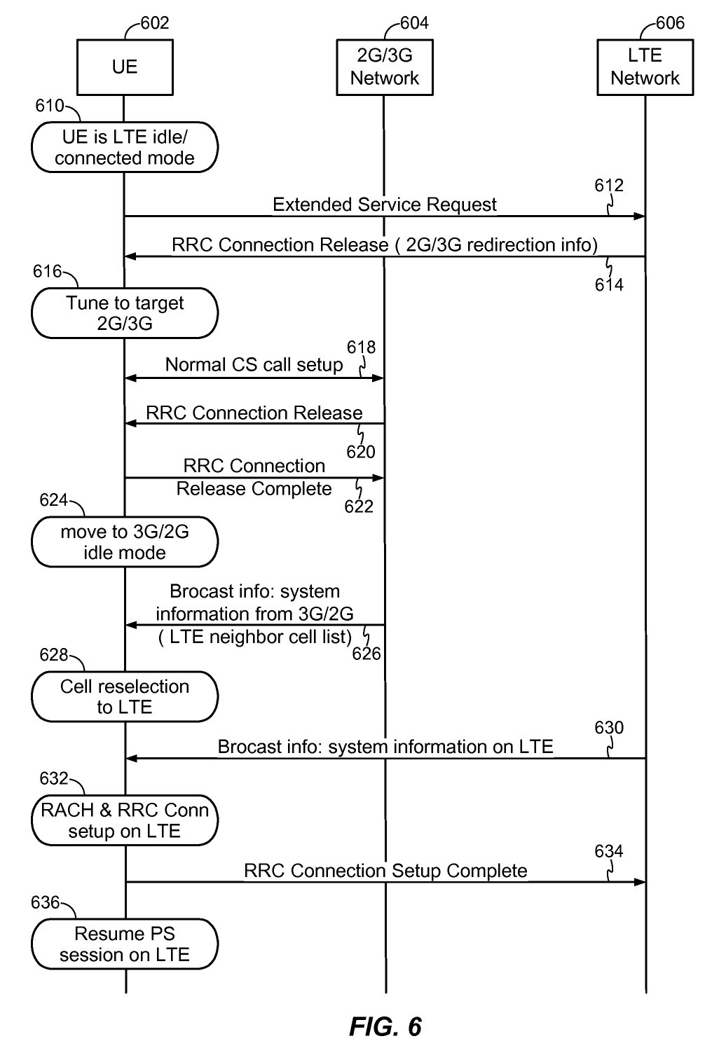

Referring to FIG. 6, a call flow diagram 600 illustrates processing with redirection information from one RAT to another RAT. At time 610, the UE 602 communicates with the LTE network 606 in idle mode or connected mode. In order to perform a particular function, for example to place a voice call, the UE 602, at time 612, sends an extended service request message so the UE 602 can disconnect from the LTE network 606 (serving RAT). The LTE network 606 sends an RRC (radio resource control) connection release message at time 614. The RRC connection release message contains 2G/3G redirection information. At time 616, the UE 602 tunes to the target RAT (2G/3G network) 604 indicated in the RRC connection release message. Next, at time 618, the circuit switched call is setup on the 2G/3G network 604. After a period of time, the UE 602 finishes the call and at time 620, the 2G/3G network 604 sends a RRC connection release message to the UE 602. The release message does not contain any redirection information from the LTE network 606. At time 622, the UE 602 sends a message to the 2G/3G network 604 indicating the RRC connection release is complete. The UE 602 moves to the 2G/3G idle mode, at time 624 and may search for another RAT. At time 626, the 2G/3G network broadcasts system information, including an LTE neighbor cell list. At time 628, the UE 602 selects a cell on the LTE network 606 and then at time 630 the UE receives broadcast information from the LTE network 606. At time 632, the UE performs a random access channel (RACH) and radio resource control (RRC) setup on the LTE network 606. At time 634, the RRC connection to the LTE network 606 is complete. The UE 602, may optionally send a tracking area update (TAU) message to the LTE network 606. At time 636, the UE resumes the packet switched session on the LTE network 606.

One aspect of the present disclosure, provides for fast return of the UE to the LTE network after completing a circuit switched transaction that was started with CSFB. The fast return does not involve the 2G/3G network. In one configuration, the LTE network is provided with information to determine whether to implement a fast return. In particular, redirection information is sent from the LTE network that includes a fast return flag that indicates whether to perform a fast return. The supplemental fast return flag reduces the time for acquiring a cell and for returning to the LTE network by eliminating the need for a full frequency scan for other RATs. In one configuration, if the fast return flag is set to true, then upon termination of a circuit switched call, the UE tunes to LTE without searching for other RATs. If the fast return flag is set to false, then the UE searches for acceptable RATs.

Additionally, in an optional configuration, the redirection information includes information indicating a desired LTE cell quality (e.g., a minimum reference signal receive power (RSRP)). In one aspect, if the quality of the cell signal meets a threshold value, then the cell is a suitable cell for connection by the UE.

In one configuration, the fast return is based on the LTE network side without involving the 2G/3G network including the MSC (mobile switching center). In another aspect, the fast return may be extended to any interRAT redirection and/or handover (not just CSFB) if the source RAT prefers fast return after call release in a target RAT.

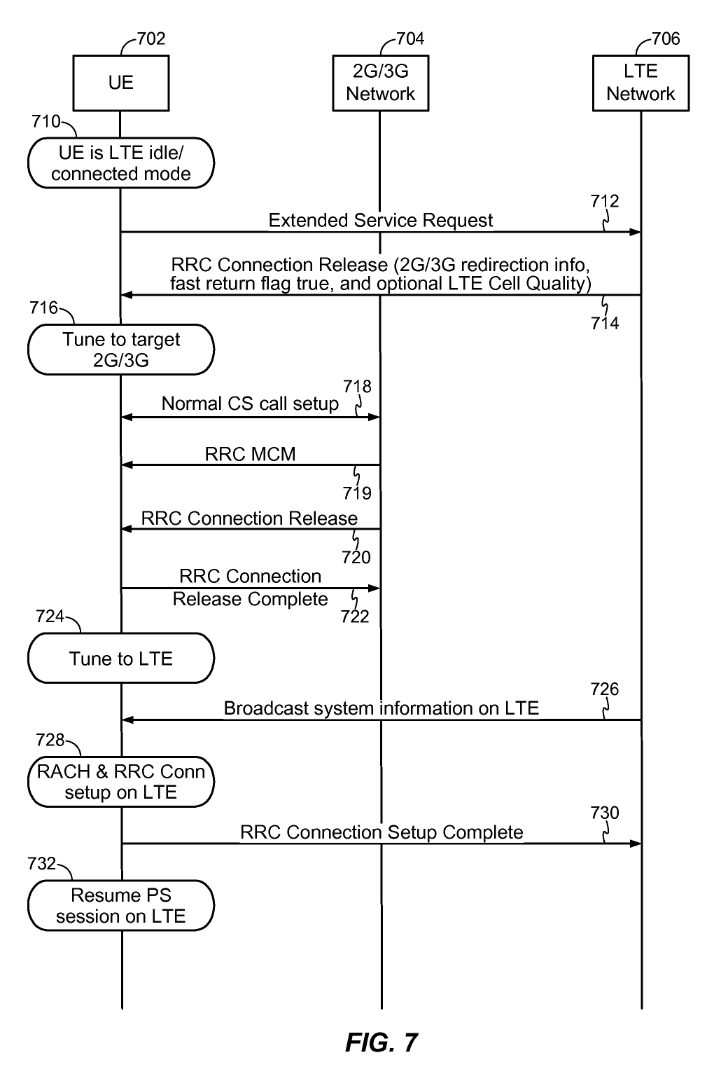

FIG. 7 illustrates a call flow of a UE performing circuit switched fall back when a fast return indication is included in the redirection information received by the UE. At time 710, the UE 702 is in LTE idle/connected mode. At time 712, the UE sends an extended service request message to the LTE network 706 (serving RAT) to prepare for the fall back. At time 714, a RRC connection release message is received by the UE 702. The redirection information includes a fast return flag which may be set to true or false. Optionally, the redirection information may also include LTE cell quality information. The RRC connection release message also includes the 2G/3G redirection information indicating the target 2G/3G network.

At time 716, the UE tunes to a target cell on the indicated 2G/3G network 704. At time 718, a normal circuit switched call is set up on the 2G/3G network 704. At time 719, the target cell sends an RRC MCM (measurement control message) to the UE 702 after the call setup. At time 720, a RRC connection release message is sent by the 2G/3G network 704 to the UE 702. If the previously received redirection information includes a fast return flag set to true, then the UE 702 will fast return to the LTE network 706. In particular, at time 722, the UE 702 sends a message to the 2G/3G network 704 indicating the RRC release is complete. Next, at time 724, the UE 702 tunes to the LTE network 706 in accordance with the fast return indication included in the redirection information. The UE 702 also receives LTE neighbor cell information in the RRC connection release message sent at time 720. At time 726, the UE 702 receives broadcast information from the LTE network 706 and at time 728 random access channel (RACH) and radio resource control (RRC) processing occurs with the LTE network 706. At time 730, the UE 702 sends a message to the LTE network 706 indicating the RRC connection setup is complete. At time 732, the UE 702 resumes a packet switched (PS) session with the LTE network 706.

In the call flow illustrated in FIG. 7, after the UE completes the circuit switched call on the 2G/3G network 704, the UE is capable of being redirected back to the LTE network 706 if a fast flag return was included in the previously received redirection message. The fast flag indication redirects the UE 702 back to the LTE network 706 and allows the UE to skip an LTE cell reselection process.

In case the LTE cell quality threshold was included in the RRC connection release message, the UE compares the measured signal quality of the acquired cell with the indicated threshold. If the measured signal quality is sufficient, the UE may camp on that cell. If the cell quality meets the threshold, the UE will camp on the LTE cell, even if the 2G/3G cell quality is very good. If the signal quality is insufficient, the UE may perform a full LTE frequency scan to locate alternative cells.

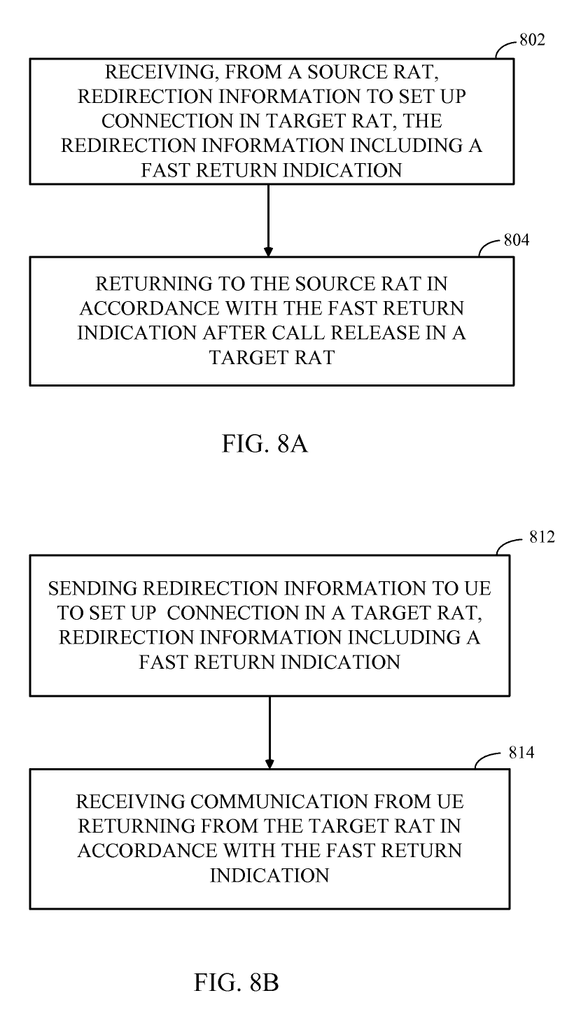

FIG. 8A is a functional block diagram illustrating example blocks executed to implement one aspect of the present disclosure. In block 802, a UE receives, from a source RAT, redirection information including a fast return indication. Next, in block 804, the UE returns to the source RAT in accordance with the fast return indication after call release in a target RAT.

FIG. 8B is a functional block diagram illustrating example blocks executed to implement one aspect of the present disclosure. In block 812, a source RAT sends redirection information to a UE to set up a connection in a target RAT. The redirection information includes a fast return indication. In block 814, the source RAT receives a communication from the UE returning from the target RAT to the source RAT in accordance with the redirection information.

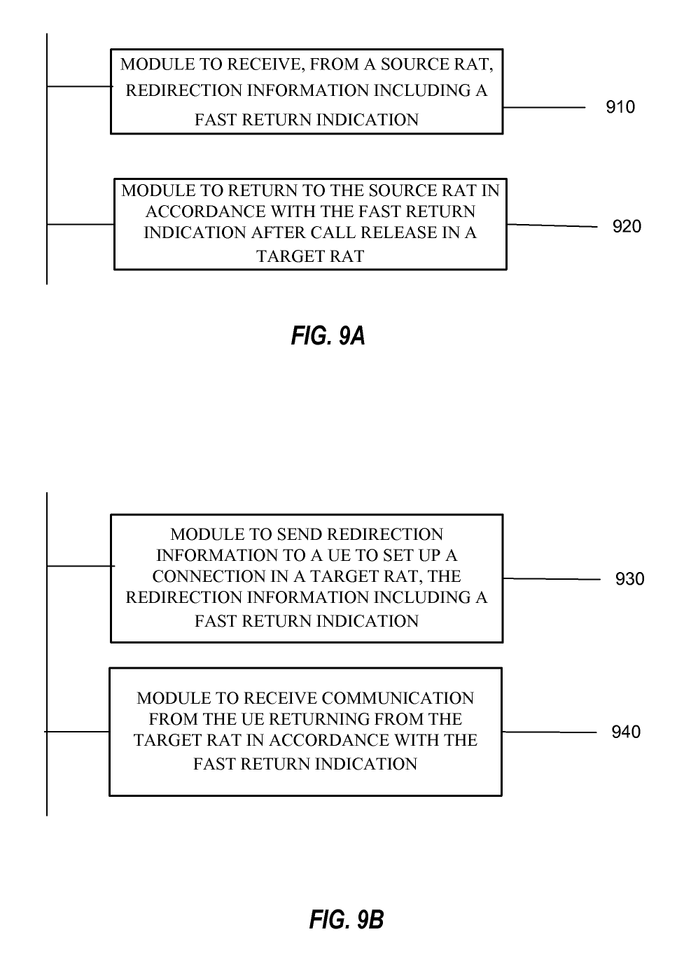

FIG. 9A shows a design of an apparatus for a UE, such as the UE 120 of FIG. 4. The apparatus includes a module 910 for receiving, from a source RAT, redirection information that includes a fast return indication. The apparatus also includes a module 920 for returning to the source RAT in accordance with the fast return indication information. after call release in a target RAT. The modules in FIG. 9A may be processors, electronics devices, hardware devices, electronics components, logical circuits, memories, software codes, firmware codes, etc., or any combination thereof

FIG. 9B shows a design of an apparatus for an eNodeB, such as the eNodeB 110 of FIG. 4. The apparatus includes a module 930 for sending redirection information to a UE to set up a connection in a target RAT. The redirection information includes a fast return indication. The apparatus also includes a module 940 for receiving communication from the UE returning from the target RAT in accordance with the fast return indication. The modules in FIG. 9B may be processors, electronics devices, hardware devices, electronics components, logical circuits, memories, software codes, firmware codes, etc., or any combination thereof.

Several aspects of a telecommunications system has been presented with reference to TD-SCDMA and TDD-LTE systems. It is noted, however, that other systems, such as FDD LTE systems are also contemplated. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving, from a source radio access technology (RAT), redirection information to set up a connection in a target RAT, the redirection information including a fast return indication; and
returning to the source RAT in accordance with the fast return indication after call release in the target RAT.

2. The method of claim 1, in which returning comprises returning to a cell of the source RAT when a signal quality of the cell meets a threshold value provided in the redirection information.

3. The method of claim 2, further comprising identifying the cell of the source RAT from one of a full scan and a target RAT message.

4. A method of wireless communication, comprising:
sending redirection information to a UE (user equipment) to set up a connection in a target RAT (radio access technology), the redirection information including a fast return indication; and
receiving communication from the UE returning from the target RAT in accordance with the fast return indication.

5. The method of claim 4, in which the redirection information provides a signal quality threshold value, and the UE returns from the target RAT when the signal quality meets the threshold value.

6. An apparatus for wireless communication, comprising:
means for receiving, from a source radio access technology (RAT), redirection information to set up a connection in a target RAT, the redirection information including a fast return indication; and
means for returning to the source RAT in accordance with the fast return indication after call release in the target RAT.

7. The apparatus of claim 6, in which the means for returning comprises returning to a cell of the source RAT when a signal quality of the cell meets a threshold value provided in the redirection information.

8. The apparatus of claim 7, further comprising means for identifying the cell of the source RAT from one of a full scan and a target RAT message.

9. An apparatus for wireless communication, comprising:
means for sending redirection information to a UE (user equipment) to set up a connection in a target RAT (radio access technology), the redirection information including a fast return indication; and
means for receiving communication from the UE returning from the target RAT in accordance with the fast return indication.

10. The apparatus of claim 9, in which the redirection information provides a signal quality threshold value, and the UE returns from the target RAT when the signal quality meets the threshold value.

11. A computer program product for wireless communication in a wireless network, comprising:
a computer-readable medium having non-transitory program code recorded thereon, the program code comprising:
program code to receive, from a source radio access technology (RAT), redirection information to set up a connection in a target RAT, the redirection information including a fast return indication; and
program code to return to the source RAT in accordance with the fast return indication after call release in the target RAT.

12. The computer program product of claim 11, in which the program code to return comprises program code to return to a cell of the source RAT when a signal quality of the cell meets a threshold value provided in the redirection information.

13. The computer program product of claim 12, further comprising program code to identify the cell of the source RAT from one of a full scan and a target RAT message.

14. A computer program product for wireless communication in a wireless network, comprising:
a computer-readable medium having non-transitory program code recorded thereon, the program code comprising:
program code to send redirection information to a UE (user equipment) to set up a connection in a target RAT (radio access technology), the redirection information including a fast return indication; and
program code to receive communication from the UE returning from the target RAT in accordance with the fast return indication.

15. The computer program product of claim 14, in which the redirection information provides a signal quality threshold value, and the UE returns from the target RAT when the signal quality meets the threshold value.

16. An apparatus for wireless communication, comprising:
a memory; and
at least one processor coupled to the memory, the at least one processor being configured:
to receive, from a source radio access technology (RAT), redirection information to set up a connection in a target RAT, the redirection information including a fast return indication; and
to return to the source RAT in accordance with the fast return indication after call release in the target RAT.

17. The apparatus of claim 16, in which the processor is further configured to return to a cell of the source RAT when a signal quality of the cell meets a threshold value provided in the redirection information.

18. The apparatus of claim 17, in which the processor is further configured to identify the cell of the source RAT from one of a full scan and a target RAT message.

19. An apparatus for wireless communication, comprising:
a memory; and
at least one processor coupled to the memory, the at least one processor being configured:
to send redirection information to a UE (user equipment) to set up a connection in a target RAT (radio access technology), the redirection information including a fast return indication; and
to receive communication from the UE returning from the target RAT in accordance with the fast return indication.

20. The apparatus of claim 19, in which the redirection information provides a signal quality threshold value, and the UE returns from the target RAT when the signal quality meets the threshold value.
